(19) United States
(12) Patent Application Publication
(10) Pub. No.: US 2025/0306227 A1
(43) Pub. Date: Oct. 2, 2025

(54) SYSTEMS AND METHODS TO PREDICT FRACTURE HEIGHT AND RECONSTRUCT PHYSICAL PROPERTY LOGS BASED ON MACHINE LEARNING ALGORITHMS AND PHYSICAL DIAGNOSTIC MEASUREMENTS

(71) Applicant: Schlumberger Technology Corporation, Sugar Land, TX (US)

(72) Inventors: Abdul Muqtadir Khan, Stafford, TX (US); Sergey Dmitrievich Parkhonyuk, Novosibirsk (RU); Denis Bannikov, Sugar Land, TX (US)

(21) Appl. No.: 18/688,510

(22) PCT Filed: Sep. 2, 2022
(86) PCT No.: PCT/US2022/042479

§ 371 Date: Mar. 1, 2024

Related U.S. Application Data
(60) Provisional application No. 63/240,528, filed on Sep. 3, 2021.

(51) Int. Cl. G01V 1/50

(52) U.S. Cl. CPC G01V 1/50; G01V 2210/1429; G01V 2210/6169; G01V 2210/646

(57) ABSTRACT

Systems and methods presented herein are configured to predict fracture height and reconstruct physical property logs using models based on machine learning algorithms and physical diagnostic measurements. In particular, physical diagnostic measurements may be used to train machine learning algorithms that can be used to predict the existence of a fracture as a function of depth. For example, physical diagnostic measurements collected by downhole sensors can be used to train the machine learning algorithms, which may then be used to predict the existence of a fracture as a function of depth based on subsequently collected physical diagnostic measurements, for example, to determine fracture height of the fracture.

### CROSS-REFERENCE TO RELATED APPLICATION

This application is a National Stage Entry of International Application No. PCT/US2022/042479, filed Sep. 2, 2022, which claims priority to and the benefit of U.S. Provisional Patent Application Ser. No. 63/240,528, entitled “A Method to Predict Fracture Height and Reconstruct Physical Property Logs Based On Machine Learning Algorithms and Physical Diagnostic Measurements,” filed Sep. 3, 2021, which is hereby incorporated by reference in its entirety for all purposes.

### BACKGROUND

The present disclosure relates to systems and methods for predicting fracture height and reconstructing physical property logs using models based on machine learning algorithms and physical diagnostic measurements.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

In tight gas formations, hydraulic fracturing treatments are often carried out in multiple stages when there are many gas bearing formation layers (e.g., pay zones) over a large depth interval in a well. It is relatively time consuming to manually design staged hydraulic fracturing treatments in tight gas formations when the number of pay zones is relatively large (e.g., over 100). The design of fracturing treatments depends on many factors, such as petrophysical and geomechanical properties of the formation. The fracture height may determine how many pay zones are stimulated by one fracture, and how many fractures are grouped into one stage. A design objective is often to have all pay zones stimulated by a number of hydraulic fractures, and to have no or minimal overlapping of fracture heights.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method that includes receiving a first set of data from one or more downhole sensors disposed in one or more wellbores of one or more wells extending through one or more subterranean formations. The first set of data relates to operating parameters of one or more fracturing operations being performed on the one or more subterranean formations. The method also includes training machine learning algorithms using the first set of data as a first set of inputs to the machine learning algorithms. The method further includes receiving a second set of data from the one or more downhole sensors disposed in the one or more wellbores of the one or more wells extending through the one or more subterranean formations. The second set of data relates to the operating parameters of the one or more fracturing operations being performed on the one or more subterranean formations. In addition, the method includes identifying one or more locations of one or more fractures through the one or more subterranean formations using the second set of data as a second set of inputs to the machine learning algorithms.

In addition, in certain embodiments, the method includes predicting one or more fracture heights of the one or more fractures based at least in part on the identified one or more locations of the one or more fractures. In addition, in certain embodiments, the method includes receiving a third set of data from the one or more downhole sensors disposed in the one or more wellbores of the one or more wells extending through the one or more subterranean formations. The third set of data relates to the operating parameters of the one or more fracturing operations being performed on the one or more subterranean formations. In addition, in certain embodiments, the method includes predicting an operating parameter of the one or more fracturing operations being performed on the one or more subterranean formations using the third set of data and the identified one or more locations of the one or more fractures as a third set of inputs to the machine learning algorithms.

In addition, in certain embodiments, training the machine learning algorithms comprises transforming the first set of data into particular features using feature engineering. In addition, in certain embodiments, training the machine learning algorithms comprises dividing the particular features into a training data set, a validation data set, and a test data set. In addition, in certain embodiments, training the machine learning algorithms comprises hyperparameter tuning back from k-fold cross-validation to the machine learning algorithms. In addition, in certain embodiments, the method includes automatically adjusting at least one of the operating parameters of the one or more fracturing operations based at least in part on the identification of the one or more locations of the one or more fractures through the one or more subterranean formations.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 is a schematic illustration of a well system extending into a subterranean formation, in accordance with embodiments of the present disclosure;

FIG. 2 is a sectional view of a vertical fracture in a layered formation, in accordance with embodiments of the present disclosure;

FIG. 3 illustrates a well control system that may include a processing system to predict fracture height and reconstruct physical property logs, in accordance with embodiments of the present disclosure;

FIG. 4 is a flow diagram of a first exemplary workflow that may be utilized by the processing system for digital database construction and machine learning implementation to identify fractures based on real physical measurements, in accordance with embodiments of the present disclosure;

FIG. 5 is a flow diagram of a second exemplary workflow that may be utilized by the processing system for digital database construction and machine learning implementation to reconstruct a full physical property log from real physical measurements, in accordance with embodiments of the present disclosure;

FIG. 6 illustrates the importance of stress contrast, which is an important property of the rock of a formation that contains a particular fracture, in accordance with embodiments of the present disclosure;

FIG. 7 illustrates various subplots that depict the fracture identification prediction of the first workflow of FIG. 4 (e.g., for digital database construction and machine learning implementation to identify fractures based on real physical measurements), in accordance with embodiments of the present disclosure; and

FIG. 8 illustrates various subplots that depict the reconstruction of a temperature log as part of the second workflow of FIG. 5 (e.g., for digital database construction and machine learning implementation to reconstruct a full physical property log from real physical measurements), in accordance with embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole,” “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface. In addition, as used herein, the terms “proximal” and “distal” may be used to refer to components that are closer to and further away from, respectively, other components being described.

In addition, as used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, by a processing system (i.e., solely by the processing system, without human intervention).

As discussed above, the design of fracturing treatments depends on many factors, such as petrophysical and geomechanical properties of a formation. Fracture height may determine how many pay zones are stimulated by one fracture, and how many fractures are grouped into one stage. A design objective is often to have all pay zones stimulated by a number of hydraulic fractures, and to have no or minimal overlapping of fracture heights. It is desirable to automatically design such staged treatments using a computer program that takes into account fracture height.

The embodiments described herein provide systems and methods for predicting fracture height and reconstructing physical property logs using models based on machine learning algorithms and physical diagnostic measurements. In particular, the embodiments described herein use physical diagnostic measurements to train machine learning algorithms that may then be used to predict the existence of a fracture as a function of depth. For example, physical diagnostic measurements collected by downhole sensors may be used to train the machine learning algorithms, which may then be used to predict the existence of a fracture as a function of depth based on subsequently collected physical diagnostic measurements, for example, to determine fracture height of the fracture.

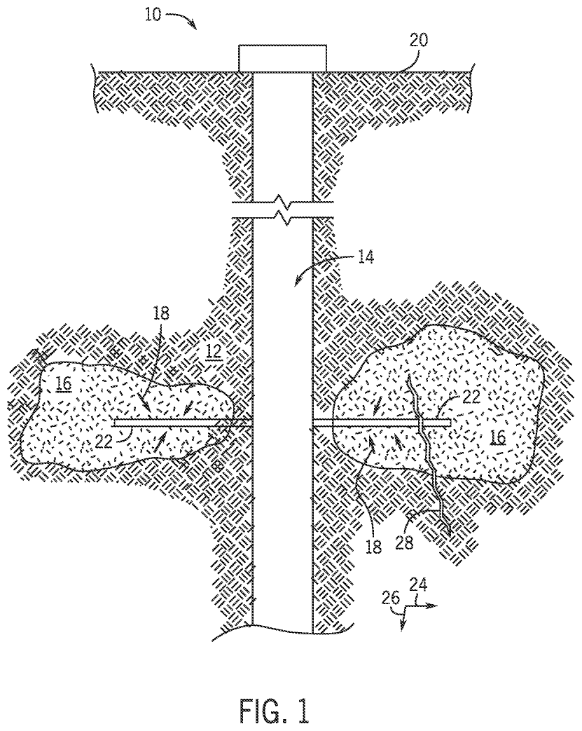

Turning now to the drawings, FIG. 1 is a schematic illustration of a well system 10 extending into a subterranean formation 12. The well system 10 enables a methodology for enhancing recovery of hydrocarbon fluid (e.g., oil and/or gas) from a well. In certain embodiments, a borehole 14 is drilled down into the subterranean formation 12. In certain embodiments, the borehole 14 may be drilled into or may be drilled outside of a target zone 16 (or target zones 16) containing, for example, a hydrocarbon fluid 18.

In the illustrated embodiment, the borehole 14 is a generally vertical wellbore extending downwardly from a surface 20. However, certain operations may create deviations in the borehole 14 (e.g., a lateral section of the borehole 14) to facilitate hydrocarbon recovery. In certain embodiments, the borehole 14 may be created in non-productive rock of the formation 12 and/or in a zone with petrophysical and/or geomechanical properties different from the properties found in the target zone or zones 16.

In certain embodiments, at least one perforation 22 may be created to intersect the borehole 14. In the illustrated embodiment, at least two perforations 22 are created to extend outwardly from the borehole 14. For example, in certain embodiments, the perforations 22 may be created and oriented laterally (e.g., generally horizontally) with respect to the borehole 14. Additionally, in certain embodiments, the perforations 22 may be oriented to extend from the borehole 14 in different directions (e.g., opposite directions) so as to extend into the desired target zone or zones 16.

In general, the perforations 22 provide fluid communication with an interior of the borehole/wellbore 14 to facilitate flow of the desired hydrocarbon fluid 18 from the perforations 22 into borehole 14 and up through the borehole 14 to, for example, a collection location at a surface 20 of the well system 10. Furthermore, in certain embodiments, the perforations 22 may be oriented in selected directions based on the material forming the subterranean formation 12 and/or based on the location of desired target zones 16.

Depending on the characteristics of the subterranean formation 12 and the target zones 16, the perforations 22 may be created along various azimuths. For example, in certain embodiments, the perforations 22 may be created in alignment with a direction of maximum horizontal stress, represented by arrow 24, in the formation 12. However, in other embodiments, the perforations 22 may be created along other azimuths, such as in alignment with a direction of minimum horizontal stress in the formation 12, as represented by arrow 26.

In certain embodiments, the perforations 22 may be created at a desired angle or angles with respect to principal stresses when selecting azimuthal directions. For example, in certain embodiments, the perforation (or perforations) 22 may be oriented at a desired angle with respect to the maximum horizontal stress in the formation 12. It should be noted that, in certain embodiments, the azimuth and/or deviation of an individual perforation 22 may be constant. However, in other embodiments, the azimuth and/or deviation may vary along the individual perforation 22 to, for example, enable creation of the perforation 22 through a desired zone 16 to facilitate recovery of the hydrocarbon fluids 18.

Additionally, in certain embodiments, at least one of the perforations 22 may be created and oriented to take advantage of a fracture 28 or multiple fractures 28, which occur in the formation 12. The fractures 28 may be used as a flow conduit that facilitates flow of the hydrocarbon fluid 18 into the perforation (or perforations) 22. Once the hydrocarbon fluid 18 enters the perforations 22, the hydrocarbon fluid 18 is able to readily flow into the wellbore 14 for production to the surface 20 and/or other collection location.

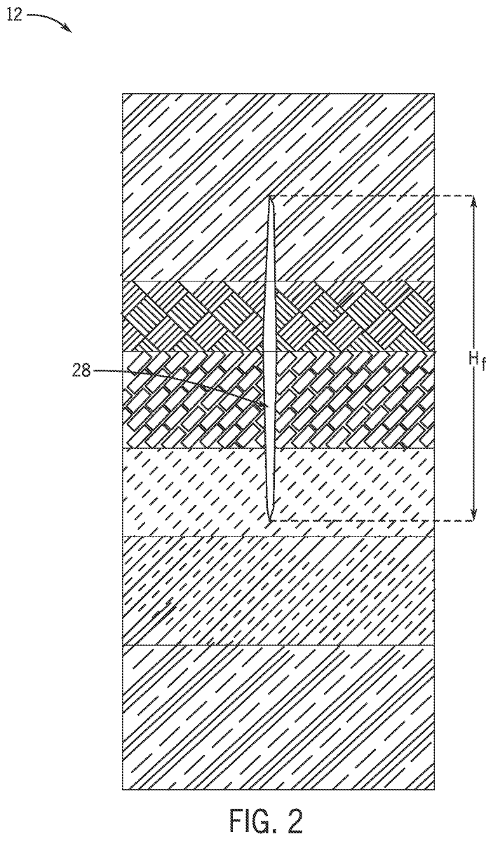

Fracture height H_{f} (e.g., the vertical height of an individual fracture 28), illustrated in FIG. 2, is a relatively important parameter to characterize and optimize a hydraulic fracturing treatment. Currently, no modelling method has been developed that can accurately model fracture height. Specifically, currently known methods are based on linear elastic fracture mechanics (LEFM) criteria and generally disregard the real-world phenomena of inelastic deformation, near-wellbore fracture initiation and propagation complexity, non-planar fracture propagation, large variance and uncertainties in the input data, required for any modeling method. Therefore, due to the lack of existing models to determine fracture height, physical measurements are made to evaluate the actual fracture height whenever required. The embodiments described herein address these shortcomings of conventional systems by utilizing an approach based on a machine learning model where existing physical measurements may be used to construct a digital database and to apply machine learning algorithms to evaluate fracture height accurately. Conventional systems do not utilize such an integration of machine learning and real physical diagnostic fracture height measurements.

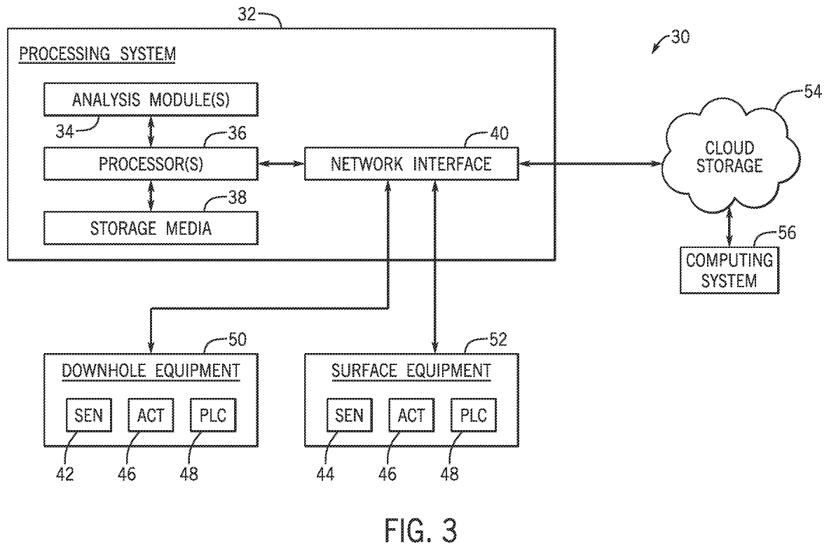

FIG. 3 illustrates a well control system 30 that may include a processing system 32 to predict fracture height and reconstruct physical property logs, as described in greater detail herein. In certain embodiments, the processing system 32 may include one or more analysis modules 34 (e.g., a program of computer-executable instructions and associated data) that may be configured to perform various functions of the embodiments described herein. In particular, described in greater detail herein, the processing system 32 may be used to predict fracture height H_{f} of one or more fractures 28 and reconstruct physical property logs using models based on machine learning algorithms and physical diagnostic measurements. In addition, in certain embodiments, the well control system 30 may utilize the analysis performed by the processing system 32 to automatically adjust fracturing operations parameters based on the analysis. In certain embodiments, to perform these various functions, an analysis module 34 executes on one or more processors 36 of the processing system 32, which may be connected to one or more storage media 38 of the processing system 32. Indeed, in certain embodiments, the one or more analysis modules 34 may be stored in the one or more storage media 38.

In certain embodiments, the one or more processors 36 may include a microprocessor, a microcontroller, a processor module or subsystem, a programmable integrated circuit, a programmable gate array, a digital signal processor (DSP), or another control or computing device. In certain embodiments, the one or more storage media 38 may be implemented as one or more non-transitory computer-readable or machine-readable storage media. In certain embodiments, the one or more storage media 38 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) 34 may be provided on one computer-readable or machine-readable storage medium of the storage media 38, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 38 may be located either in the machine running the machine-readable instructions, or may be located at a remote site from which machine-readable instructions may be downloaded over a network for execution.

In certain embodiments, the processor(s) 36 may be connected to a network interface 40 of the processing system 32 to allow the processing system 32 to communicate with the various downhole sensors 42 (e.g., as part of a downhole tool) and surface sensors 44 (e.g., associated with equipment at the surface 20 of the well system 10), as well as communicate with actuators 46 and/or PLCs 48 of downhole equipment 50 and surface equipment 52 (primarily downhole sensors 42 of downhole equipment 50 in the context of the present embodiments). In certain embodiments, the network interface 40 may also facilitate the processing system 32 to communicate data to cloud storage 54 (or other wired and/or wireless communication network) to, for example, archive data and/or to enable external computing systems 56 to access data and/or to remotely interact with the processing system 32.

It should be appreciated that the well control system 30 illustrated in FIG. 3 is only one example of a well control system, and that the well control system 30 may have more or fewer components than shown, may combine additional components not depicted in the embodiment of FIG. 3, and/or the well control system 30 may have a different configuration or arrangement of the components depicted in FIG. 3. In addition, the various components illustrated in FIG. 3 may be implemented in hardware, software, or a combination of both hardware and software, including one or more signal processing and/or application specific integrated circuits. Furthermore, the operations of the well control system 30 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

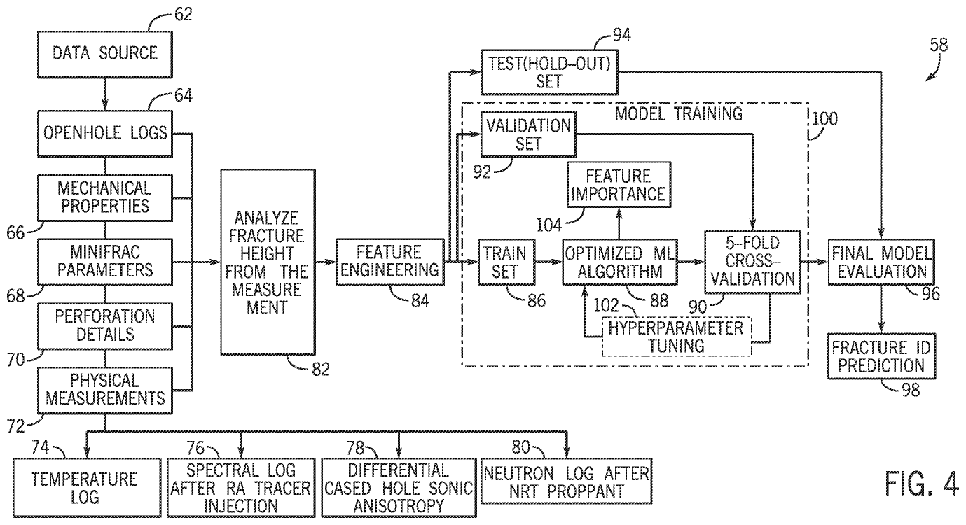

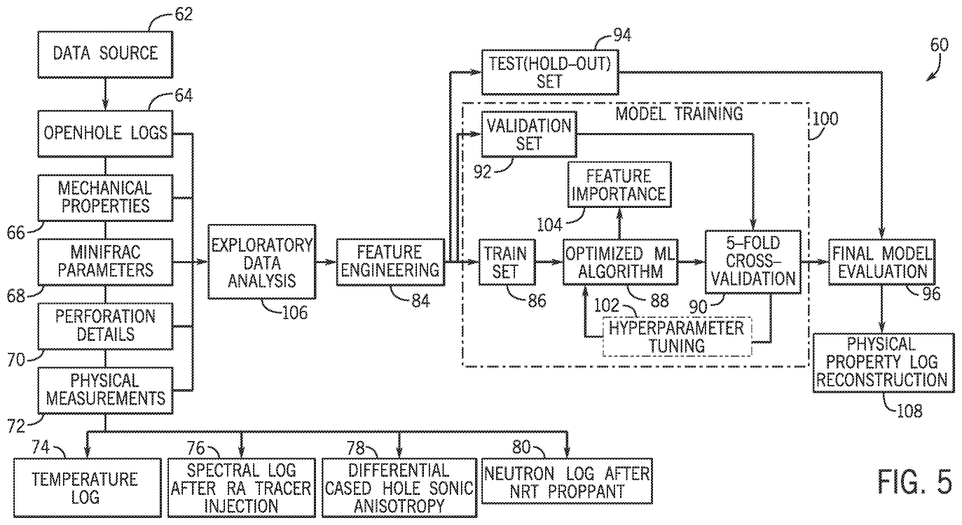

The fracture height prediction techniques described herein generally have two separate components: (1) a fracture identification model, and (2) physical property log reconstruction. FIG. 4 is a flow diagram of a first exemplary workflow 58 (e.g., data and process steps) that may be utilized by the processing system 32 for digital database construction and machine learning implementation to identify fractures based on real physical measurements, and FIG. 5 is a flow diagram of a second exemplary workflow 60 (e.g., data and process steps) that may be utilized by the processing system 32 for digital database construction and machine learning implementation to reconstruct a full physical property log from real physical measurements.

As illustrated in FIG. 4, in certain embodiments, the first workflow 58 may access a data source 62 (e.g., digital database) that includes relatively static (and/or previously collected) data such as openhole logs 64, mechanical properties 66, minifrac (e.g., a relatively small fracturing treatment performed before the main hydraulic fracturing treatment) parameters 68, perforation details 70, and so forth, as well as physical measurements 72 collected in substantially real time (e.g., using the downhole sensors 42 described above), such as temperature logs 74, spectral logs 76 (e.g., after radioactive tracer injection), differential cased hole sonic anisotropy 78, neutron logs 80 (e.g., after nonradioactive tracer proppant injection), and so forth.

Table 1 below illustrates but one non-limiting example of the input variables and dependencies that may affect the determination of fracture height growth, as described in greater detail herein. For example, the equation below may be used:

$$E = \frac{2 \cdot {P}_{net} \cdot {h}_{f}}{{w}_{f}}$$

where E (5) is the Young's modulus, w_{f} is the fracture width, and h_{f} is the fracture height. Fluid volume (8) and injection rate (9) affect the width and net pressure (i.e., Pₙₑₜ (10)). As illustrated in FIG. 1, perforations 22 are the communication of fluid to the rock of the formation 12 and, hence, fractures 28 initiate at the perforations 22. Therefore, the properties related to perforations (6, 7) directly affect the fracture height analysis because the temperature is lowest there.

TABLE 1

| Category | No. | Variable | Unit | Description |
|---|---|---|---|---|
| Openhole | 1 | Corrected bulk density | g/cm³ | Continuous data along with the measured depth |
| Logs | 2 | Gamma-ray | gAPI | Continuous data along with the measured depth |
| | 3 | Total porosity | v/v | Continuous data along with the measured depth |
| Calculated | 4 | Minimum horizontal principal stress | psi | Continuous data along with the measured depth |
| Mechanical | 5 | Elastic Young's modulus | psi | Continuous data along with the measured depth |
| Properties | | | | |
| Perforation | 6 | Perforation interval | — | Binary classification with 0 and 1 labels |
| Parameters | 7 | Distance from perforation | ft | Calculated for each measured depth |
| Minifrac | 8 | Crosslinked fracturing fluid volume | bbl | Single point entry |
| Parameters | 9 | Injection rate | bbl/min | Single point entry |
| | 10 | End of treatment net pressure | psi | Single point entry |
| Post- | 11 | Temperature | ° F. | Continuous temperature log data along with the |
| Treatment | | | | measured depth |
| Logs | | | | |
| Analyzed | 12 | Fracture interpretation label | — | Binary 0 and 1 labels for fracture presence based on |
| Result | | | | technical domain expertise interpretation |

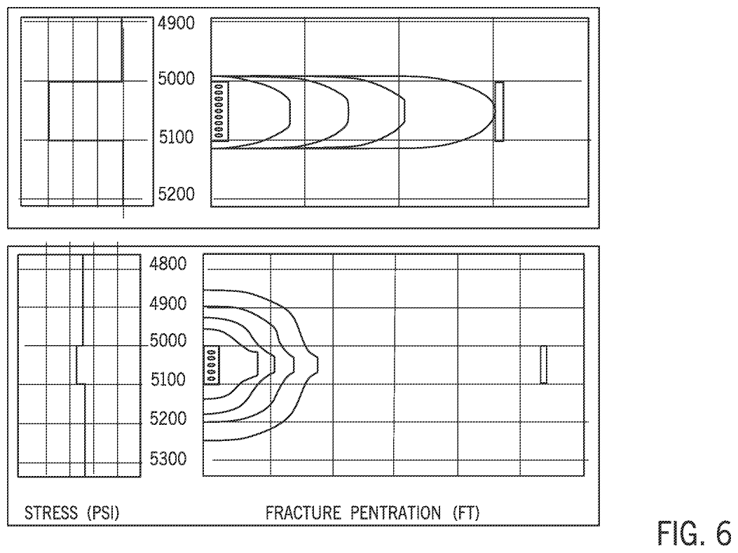

FIG. 6 illustrates the importance of stress contrast, which is an important property of the rock of the formation 12 that contains a particular fracture 28. Therefore, the principal stress (4) directly affects the fracture height growth. Gamma ray (2) and bulk density (1) affect the rock minerology, which in turn affects the elasticity/plasticity variations of the rock, of the formation 12 and those variations act as a lithologic barrier to fracture growth and, hence, affect fracture growth. In addition, porosity (3) affects fluid emission and may enhance leakoff where higher porosity zones are available. In addition, this leakoff may cause cooldown, which may be captured in a temperature log.

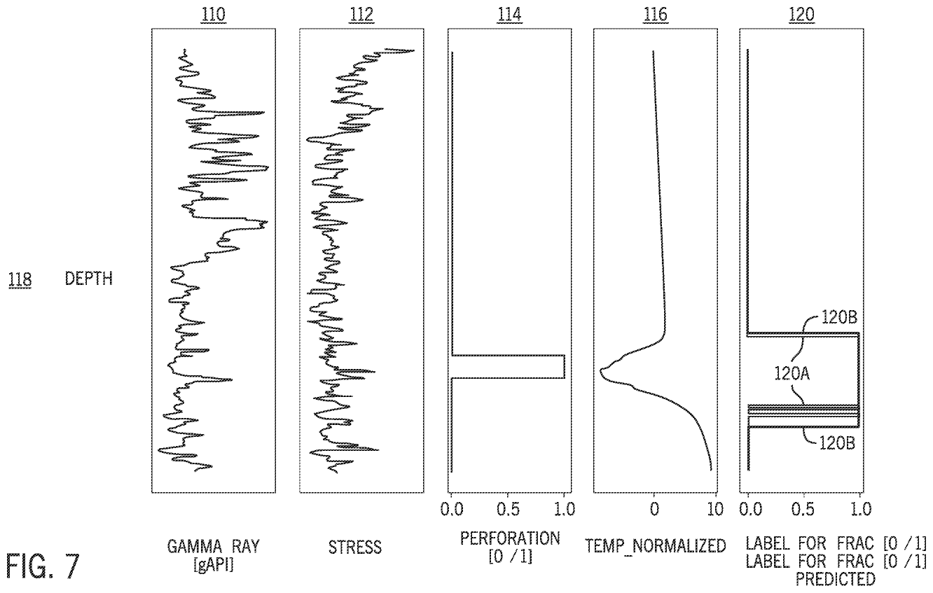

In certain embodiments of the first workflow 58, all of the data stored in the data source 62 (e.g., digital database) may be used to analyze the fracture height of one or more fractures 28 (block 82), and the data from the analysis may be transformed into particular features using feature engineering 84 (e.g., machine learning that leverages the data to create new variables that are not in the training set). In addition, in certain embodiments, the output of the feature engineering 84 may be divided into various sets of data including, but not limited to: (1) a training data set 86 that is used to optimize machine learning algorithms 88, which may lead to a k-fold cross-validation 90 (e.g., where k=5 in the illustrated embodiment) where the training data set 86 is split into k subsets (e.g., folds) where each fold is used as a training set at some point; (2) a validation data set 92 that is used to validate the k-fold cross-validation 90 of the optimized machine learning algorithms 88; and (3) a test (e.g., hold-out) data set 94 that is used during final model validation 96 of the k-fold cross-validation 90 of the optimized machine learning algorithms 88, which leads to fracture identification prediction 98 (e.g., as described below with reference to FIG. 7). As such, the training data set 86 and the validation data set 92 are used for model training 100 (e.g., of the optimized machine learning algorithms 88), whereas the test (e.g., hold-out) data set 94 is used for final model validation 96 of the k-fold cross-validation 90 of the optimized machine learning algorithms 88.

Feature Engineering 84 incorporates artificial features into an algorithm using normalization and scaling techniques. This exercise allows multiple variables to be used with different units and measures in the same calculation systems. In certain embodiments, feature engineering techniques may be sensitized to enhance the prediction performance metrics of the model. As but one non-limiting example, for temperature reconstruction, the following features may be calculated:
1. Normalized measured depth (MD*)

$$M {D}^{*} = ( M D - M {D}_{min} ) / ( {MD}_{max} - M {D}_{min} )$$

where MDₘᵢₙ and MDₘₐₓ defined based on numerous unique wells obtained after data cleaning step.
2. Normalized temperature calculated by deducting first observed temperature for a log from each temperature measurement of the same log:

$$Normalized temperature = Temperature - Temperature [ 0 ]$$

Normalization is a widely used approach to make variables vary and scale in a certain comparable range.
3. Distance from current depth to the top of perforation interval depth:

$$Distance to perforation top = Normalized measured depth ( {MD}^{*} ) - {MD}_{perf top}^{*} .$$

4. Distance from current depth to the bottom of perforation interval depth:

$$Distance to perforation bottom = {MD}^{*} - M {D}_{perf bottom}^{*} .$$

Although features 2 and 3 are highly correlated, they may help to increase the accuracy of the final model. In cases where millions of datapoints are used for modeling, algorithm run times may be relatively long and certain features may be eliminated. However, for small datasets with relatively fast convergence times, feature elimination may be ignored.
5. Absolute distance from current depth to the middle of perforation interval:

$$Absolute distance to perforation middle = abs ( {MD}^{*} - {MD}_{perf mid}^{*} ) ,$$

$$where {MD}_{perf mid}^{*} = ( {MD}_{perf top}^{*} + {MD}_{perf bot}^{*} ) / 2 ,$$

As illustrated in FIG. 4, in certain embodiments, the model training 100 may include hyperparameter tuning 102 back from the k-fold cross-validation 90 to the optimized machine learning algorithms 88, for example, where fracture height of one or more fractures 28 is used to control the learning process of the optimized machine learning algorithms 88. In addition, in certain embodiments, the optimized machine learning algorithms 88 may be used to determine certain feature importance 104, which may be leveraged during the learning process of the optimized machine learning algorithms 88.

As illustrated in FIG. 5, the second workflow 60 (e.g., for digital database construction and machine learning implementation to reconstruct a full physical property log from real physical measurements) is substantially similar to the first workflow illustrated in FIG. 4 (e.g., for digital database construction and machine learning implementation to identify fractures based on real physical measurements) except for a few implementation modifications. For example, as illustrated in FIG. 5, in certain embodiments, the second workflow 60 may also access the data source 62 that includes the relatively static (and/or previously collected) data such as the openhole logs 64, the mechanical properties 66, the minifrac (e.g., a relatively small fracturing treatment performed before the main hydraulic fracturing treatment) parameters 68, the perforation details 70, and so forth, as well as the physical measurements 72 collected in substantially real time (e.g., using the downhole sensors 42 described above), such as the temperature logs 74, the spectral logs 76 (e.g., after radioactive tracer injection), the differential cased hole sonic anisotropy 78, the neutron logs 80 (e.g., after nonradioactive tracer proppant injection), and so forth.

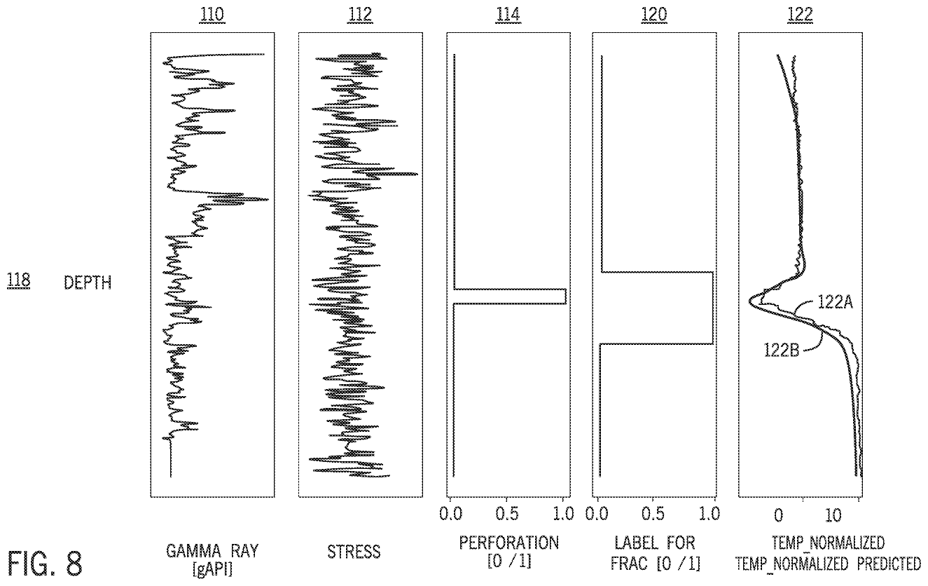

In certain embodiments of the second workflow 60, all of the data stored in the data source 62 (e.g., digital database) may be used in exploratory data analysis 106, and the data from the analysis may be transformed into particular features using feature engineering 84 (e.g., machine learning that leverages the data to create new variables that are not in the training set). In addition, in certain embodiments, the output of the feature engineering 84 may also be divided into various sets of data including, but not limited to: (1) a training data set 86 that is used to optimized machine learning algorithms 88, which may lead to a k-fold cross-validation 90 (e.g., where k=5 in the illustrated embodiment) where the training data set 86 is split into k subsets (e.g., folds) where each fold is used as a training set at some point; (2) a validation data set 92 that is used to validate the k-fold cross-validation 90 of the optimized machine learning algorithms 88; and (3) a test (e.g., hold-out) data set 94 that is used during final model validation 96 of the k-fold cross-validation 90 of the optimized machine learning algorithms 88, which leads to physical property log reconstruction 108 (e.g., as described below with reference to FIG. 8). As such, the training data set 86 and the validation data set 92 are again used for model training 100 (e.g., of the optimized machine learning algorithms 88), whereas the test (e.g., hold-out) data set 94 is used for final model validation 96 of the k-fold cross-validation 90 of the optimized machine learning algorithms 88.

As illustrated in FIG. 5, in certain embodiments, the model training 100 may again include hyperparameter tuning 102 back from the k-fold cross-validation 90 to the optimized machine learning algorithms 88, for example, where fracture height of one or more fractures 28 is used to control the learning process of the optimized machine learning algorithms 88. In addition, in certain embodiments, the optimized machine learning algorithms 88 may again be used to determine certain feature importance 104, which may be leveraged during the learning process of the optimized machine learning algorithms 88.

It will be appreciated that both the first and second workflows 58, 60 may be performed iteratively such that outputs of one iteration of the first and second workflows 58, 60 may be stored in the data store 62 and used in another iteration of the first and second workflows 58, 60. Furthermore, in certain embodiments, data used in iterations of the first and second workflows 58, 60 may relate to different well systems 10 such that the model training 100 may be general in nature, and not specific to a particular well system 10. For example, data relating to a first well system 10 may be used in iterations of the first workflow 58, and then data relating to a second well system 10 may be used in iterations of the second workflow 60 after training of the optimized machine learning algorithms 88 has begun (e.g., via the iterations of the first workflow 58). As such, the machine learning that takes place over time may be carried over to future modelling of other well systems 10.

FIG. 7 illustrates various subplots that depict the fracture identification prediction of the first workflow 58 of FIG. 4 (e.g., for digital database construction and machine learning implementation to identify fractures based on real physical measurements). For example, as illustrated, in certain embodiments, the first four subplots represent inputs fed through the digital database 62 (e.g., including physical measurements 72 collected in substantially real time using the downhole sensors 42 described above) for the analysis of the fracture height of one or more fractures 28, as described in greater detail with reference to FIG. 4. Specifically, the inputs illustrated in FIG. 7 include gamma ray measurements 110 (e.g., illustrated as a log of total natural radioactivity, measured in API units) from the formation 12, stress measurements 112 within the formation 12, the existence 114 (or non-existence, with 1=existence and 0=non-existence) of a perforation 22 through the formation 12, and normalized temperature measurements 116 of the formation 12, each plotted versus depth 118 within the wellbore 14. In certain embodiments, these inputs relate to operating parameters of fracturing operations being performed on the formation 12.

An example fracture identification prediction 120 is shown in the rightmost subplot after fracturing treatment. Specifically, the fracture identification prediction is shown as line 120A, whereas the actual fracture existence is shown as line 120B. As such, the model allows for direct fracture height prediction. As illustrated in FIG. 7, for a given set of input well parameters, the model predicts a binary classification at each depth 118 (e.g., with 1=existence of a fracture at a given depth 118 and 0=non-existence of a fracture at a given depth 118). One advantage of this model is that a non-fracturing expert can use the fracture identification prediction 120 and obtain required results.

In addition, FIG. 8 illustrates various subplots that depict the reconstruction of a temperature log as part of the second workflow 60 of FIG. 5 (e.g., for digital database construction and machine learning implementation to reconstruct a full physical property log from real physical measurements). For example, as illustrated, in certain embodiments, the first four subplots represent inputs fed through the digital database 62 (e.g., including physical measurements 72 collected in substantially real time using the downhole sensors 42 described above) for the reconstruction of a physical property log. Specifically, the inputs illustrated in FIG. 8 include gamma ray measurements 110 (e.g., illustrated as a physical property log of total natural radioactivity, measured in API units) from the formation 12, stress measurements 112 within the formation 12, and the existence 114 (or non-existence, with 1=existence and 0=non-existence) of a perforation 22 through the formation 12.

However, in this embodiment, the fracture identification prediction 120 determined with reference to FIG. 7 (e.g., using the first workflow 58 of FIG. 4) may be used as a fourth input, and the predicted output may be an operating parameter of fracturing operations being performed on the formation 12, such as normalized temperature 122 of the formation 12 (e.g., as opposed to using normalized temperature measurements 116 of the formation 12 as in FIG. 7) shown in the rightmost subplot after fracturing treatment, with the predicted temperature shown as line 122A and the actual temperature shown as line 122B.

As such, the model allows for full reconstruction of a virtual log for a physical property used to evaluate the fracture height (e.g., as illustrated with reference to FIG. 7). As illustrated in FIG. 8, for a given set of input well parameters, the model predicts a physical property log subplot (e.g., a temperature cooldown subplot, a gamma ray subplot, etc.), which a fracturing expert can use to decipher the fracture height. This methodology removes interpretation subjectivity from the model, freeing the model of any inherent prediction bias.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method, comprising:
receiving a first set of data from one or more downhole sensors disposed in one or more wellbores of one or more wells extending through one or more subterranean formations, wherein the first set of data relates to operating parameters of one or more fracturing operations being performed on the one or more subterranean formations;
training machine learning algorithms using the first set of data as a first set of inputs to the machine learning algorithms;
receiving a second set of data from the one or more downhole sensors disposed in the one or more wellbores of the one or more wells extending through the one or more subterranean formations, wherein the second set of data relates to the operating parameters of the one or more fracturing operations being performed on the one or more subterranean formations; and
identifying one or more locations of one or more fractures through the one or more subterranean formations using the second set of data as a second set of inputs to the machine learning algorithms.

2. The method of claim 1, comprising predicting one or more fracture heights of the one or more fractures based at least in part on the identified one or more locations of the one or more fractures.

3. The method of claim 1, comprising:
receiving a third set of data from the one or more downhole sensors disposed in the one or more wellbores of the one or more wells extending through the one or more subterranean formations, wherein the third set of data relates to the operating parameters of the one or more fracturing operations being performed on the one or more subterranean formations; and
predicting an operating parameter of the one or more fracturing operations being performed on the one or more subterranean formations using the third set of data and the identified one or more locations of the one or more fractures as a third set of inputs to the machine learning algorithms.

4. The method of claim 1, wherein training the machine learning algorithms comprises transforming the first set of data into particular features using feature engineering.

5. The method of claim 4, wherein training the machine learning algorithms comprises dividing the particular features into a training data set, a validation data set, and a test data set.

6. The method of claim 1, wherein training the machine learning algorithms comprises hyperparameter tuning back from k-fold cross-validation to the machine learning algorithms.

7. The method of claim 1, comprising automatically adjusting at least one of the operating parameters of the one or more fracturing operations based at least in part on the identification of the one or more locations of the one or more fractures through the one or more subterranean formations.

8. A tangible, non-transitory machine-readable medium, comprising processor-executable instructions that, when executed by at least one processor, cause the at least one processor to:
receive a first set of data from one or more downhole sensors disposed in one or more wellbores of one or more wells extending through one or more subterranean formations, wherein the first set of data relates to operating parameters of one or more fracturing operations being performed on the one or more subterranean formations;
train machine learning algorithms using the first set of data as a first set of inputs to the machine learning algorithms;
receive a second set of data from the one or more downhole sensors disposed in the one or more wellbores of the one or more wells extending through the one or more subterranean formations, wherein the second set of data relates to the operating parameters of the one or more fracturing operations being performed on the one or more subterranean formations; and
identify one or more locations of one or more fractures through the one or more subterranean formations using the second set of data as a second set of inputs to the machine learning algorithms.

9. The tangible, non-transitory machine-readable medium of claim 8, wherein the processor-executable instructions, when executed by the at least one processor, cause the at least one processor to predict one or more fracture heights of the one or more fractures based at least in part on the identified one or more locations of the one or more fractures.

10. The tangible, non-transitory machine-readable medium of claim 8, wherein the processor-executable instructions, when executed by the at least one processor, cause the at least one processor to:
receive a third set of data from the one or more downhole sensors disposed in the one or more wellbores of the one or more wells extending through the one or more subterranean formations, wherein the third set of data relates to the operating parameters of the one or more fracturing operations being performed on the one or more subterranean formations; and
predict an operating parameter of the one or more fracturing operations being performed on the one or more subterranean formations using the third set of data and the identified one or more locations of the one or more fractures as a third set of inputs to the machine learning algorithms.

11. The tangible, non-transitory machine-readable medium of claim 8, wherein training the machine learning algorithms comprises transforming the first set of data into particular features using feature engineering.

12. The tangible, non-transitory machine-readable medium of claim 11, wherein training the machine learning algorithms comprises dividing the particular features into a training data set, a validation data set, and a test data set.

13. The tangible, non-transitory machine-readable medium of claim 8, wherein training the machine learning algorithms comprises hyperparameter tuning back from k-fold cross-validation to the machine learning algorithms.

14. A system, comprising:
one or more downhole sensors disposed in one or more wellbores of one or more wells extending through one or more subterranean formations, wherein the one or more sensors are configured to detect operating parameters of one or more fracturing operations being performed on the one or more subterranean formations;
a processing system configured to:
receive a first set of data from the one or more downhole sensors;
train machine learning algorithms using the first set of data as a first set of inputs to the machine learning algorithms;
receive a second set of data from the one or more downhole sensors; and
identify one or more locations of one or more fractures through the one or more subterranean formations using the second set of data as a second set of inputs to the machine learning algorithms.

15. The system of claim 14, wherein the processing system is configured to predict one or more fracture heights of the one or more fractures based at least in part on the identified one or more locations of the one or more fractures.

16. The system of claim 14, wherein the processing system is configured to:
receive a third set of data from the one or more downhole sensors; and
predict an operating parameter of the one or more fracturing operations being performed on the one or more subterranean formations using the third set of data and the identified one or more locations of the one or more fractures as a third set of inputs to the machine learning algorithms.

17. The system of claim 14, wherein training the machine learning algorithms comprises transforming the first set of data into particular features using feature engineering.

18. The system of claim 14, wherein training the machine learning algorithms comprises dividing the particular features into a training data set, a validation data set, and a test data set.

19. The system of claim 14, wherein training the machine learning algorithms comprises hyperparameter tuning back from k-fold cross-validation to the machine learning algorithms.

20. The system of claim 14, comprising a well control system configured to automatically adjust at least one of the operating parameters of the one or more fracturing operations based at least in part on the identification of the one or more locations of the one or more fractures through the one or more subterranean formations.
